(19) United States
(12) Patent Application Publication
(10) Pub. No.: US 2002/0156757 A1
(43) Pub. Date: Oct. 24, 2002

(54) Electronic product design system

(76) Inventor: Don Brown, Warrington, PA (US)

Correspondence Address: BLANK ROME COMISKY & MCCAULEY, LLP, 900 17TH STREET, N.W., SUITE 1000, WASHINGTON, DC, 20006, US

(21) Appl. No.: 09/570,027

(22) Filed: May 12, 2000

(51) Int. Cl. G06F 7/00

(52) U.S. Cl. 707/1

(57) ABSTRACT

A product design system has a workstation, central web site and vendor databases. The workstation includes access to one or more design tools that are used by a user, such as a product designer, to formulate a design. The vendor databases have one or more vendor data files that have vendor-supplied data associated with a different material, process, component, or the like that is offered by the vendor. The vendor data files have a standardized database structure that is suitable to one or more design tools stored at the workstation. Each vendor database and vendor data file is associated with a URL that is searchable. A user at the workstation accesses the central web site and conducts a search of desired vendor-supplied data. Results are presented to the user, who may then reformat or edit the search or download the located vendor-supplied data into a vendor-supplied database at the workstation. The vendor-supplied data can then be imported from the vendor-supplied database into any of the design tools. The design tool creates a design file that is stored at the workstation and can be transported to any different design tool through a Neutral Dynamic Hub, which first converts the design file to a neutral format and then to a format suitable to the destination design tool.

### BACKGROUND OF THE INVENTION

1. Field of the Invention

The present invention relates to a system for designing products. More particularly, the present invention relates to a system that provides an interface between different levels of a supply chain, and especially between product designers and vendors which contains reliable materials data, component data, models and manufacturing process and testing data for a particular industry, such as the wireless electronic product industry.

2. Description of the Background Art

In order to bring a new product to market, an original equipment manufacturer (OEM) at the top of the supply chain must progress through various phases or levels of product development. Similarly, each level of the supply chain must interact with other levels of the supply chain. In the wireless electronic product industry, for instance, the top-level OEM must address all levels of the design, from device technology to system. At each level of the supply chain, the designer must create the initial product specifications, locate vendors, materials, components and processes, design with and analyze those materials and processes with various EDA (Electronic Design Automation) tools, prototype and then ultimately produce the newly developed product(s).

The supply chain hierarchy in the wireless industry, for instance, includes the Service Provider (such as a telecommunications company or the like), Systems vendors (such as cell phones, pagers, satellites, base stations), Sub-Systems vendors (such as filters, mixers, amplifiers), Packaged Components vendors, Unpackaged Component vendors, Engineered Materials and Raw Materials vendors. The product designer at the various levels of the supply chain must work with various vendors at other levels of the supply chain, including raw materials (such as ceramic, polymer, metal); engineered materials (such as circuit boards, shielding, substrates); active device technology; passive device technology; device interconnect; substrate interconnect; shielding and system packaging.

There is a complex interaction within and between different levels of the wireless industry supply chain. Each level wants to know what is available from the other levels, both above and below. And, each level wants to sell its products or services to any other “appropriate” level—typically above it, but sometimes below its level. Similar supply chain structures exist in other industries.

Product designers at the various levels of the supply chain work with various EDA tools to design and simulate various features of a new product, such as the design and performance of an electronic circuit. Those EDA tools include but are not limited to mechanical, thermal, fluid, electrical, systems design, circuit design, electro-magnetic design tools for device, sub-system and system design.

It is estimated that there are over 500,000 electronic designers worldwide, and it is estimated that there are over 5,000 suppliers of everything in the supply chain. Those vendors and designers typically use different EDA tools and/or platforms. Due to the different vendors having different EDA tools, formats, design and data platforms and testing methods, information is often difficult to obtain and compare. Consequently, there is often a wide communication gap between OEMs, service providers and their vendors between all levels of the supply chain.

In the wireless product industry, service providers typically evaluate portable wireless device vendors several times a year and often make a buying decision based on as little as 25 cents difference in product price. Portable wireless product vendors design and build between approximately 30-50 new products per year, ranging from simple software changes to major new device platforms. Those portable wireless products service various combinations of all the different wireless air interface requirements in the world, including but not limited to GSM (Global System for Mobile communications), AMP S (Advanced Mobile Phone Service), CDMA (Code Division Multiple Access), TDMA (Time Division Multiple Access), 3G and WCDMA (Wideband Code Division Multiple Access).

As a result, portable wireless product makers are under intense pressure to come to market with new products that meet the needs of the consuming public at a price point which the service providers can support. If a portable wireless device maker is as little as 1-2 months late to market, the OEM might have to start a new design cycle all over again for a new device.

Currently, it takes about 18 months to bring a new wireless platform from specifications to market, whereas the normal product life cycle is around 12 months. It can take up to twenty times longer for a designer to locate and accommodate a product or service (whether a known or a new vendor) for a new material and/or manufacturing process compared to the time to remain with a previously-used material and/or process. That extra time adds valuable days, weeks or months to bring a product market. Hence, it is often not economical for a product designer to investigate new materials and processes, even if the new material or process offers lower manufacturing costs and/or faster time to market. That delay is due, in large part, to the time it takes a designer to find out about and collect sufficient and accurate information on the new material, component and/or manufacturing process.

There are also significant delays and difficulties in moving files and data to and from different EDA platforms. The time and effort necessary to transfer files between different and/or special purpose EDA tools often requires the time-consuming process of re-entering data and redrawing designs. That re-entry process is also highly prone to errors that can be costly, especially if the error is not discovered until late in the prototype or manufacturing process.

### SUMMARY OF THE INVENTION

In view of the foregoing, one object of the present invention is to provide a product design system that decreases time to market, reduces design and manufacturing costs and improves product performance. It is another object of the present invention to provide a product design system that has a common language and format and can be accessed by all levels of the supply chain, such as Service Providers, Systems, Sub-systems, Packaged Components, Unpackaged Components, Engineered Materials and Raw Materials. It is a further object of the invention to provide a product design system that improves design-to-prototype and design-to-manufacture, using vendor data from all levels of the supply chain in a standardized data format and to integrate mechanical, electrical, electromagnetic, thermal and other EDA design tools that can be used by product designers at all levels of the supply chain.

Another object of the invention is to provide a product design system that enables the designer to access data at all levels of the supply chain. It is yet another object of the invention to provide a product design system that addresses all layers of the design process, from device technology to system. It is still a further object of the invention to provide a product design system that enables files and data to be transferred among different tools without having to reenter data or redraw designs.

Accordingly, the present invention comprises an Electronic Product Design System (EPDeS) which allows for seamless interaction between any level of the supply chain to any other level and it allows the seamless sharing of data. The system has a workstation, information interface centralized web site and vendor databases. The workstation has various EDA tools that are used by a product designer to develop new products. The product designer uses the workstation to access the website in order to search for information amongst the various vendor databases. Information located as a result of the search is first viewable and, if so desired, can be downloaded to the workstation as a vendor-supplied database so that it can then be used by the EDA tools. Information is stored in the vendor-supplied databases in a standardized database structure so that the information can be shared by, and imported into, the various EDA tools. In addition, a product designer can transfer information between various EDA tools on the local workstation, between workstations for use by other product designers and can collaborate with vendors having different EDA tools.

The vendor databases have standardized database structures and retain vendor-supplied data for materials, design rules, models (electrical, electromagnetic, thermal, mechanical, fluid, etc.) and components in a format that is easily used by EDA tool(s). Different standardized database format structures are used for different product/process areas, including materials, models, design rules and components. Preferably, however, each type of product/process data has a single standardized format, though different versions of that format can be provided. For example, all materials data (for ceramic, metal, plastic, etc.) is held in a common database structure which allows for all of the materials properties to be identified under various conditions of temperature, frequency of operation, time, humidity, etc. Of course, more than one standardized format structure can be provided for a given type of data, or similar format structures can be used for similar types of data. Different standardized database structures can be used, for example, for materials, models, design rules and components.

By using a standardized database structure for the vendor databases, vendor-supplied data can be quickly and easily searched, evaluated and compared by sellers/vendors and designers/buyers. Vendors/sellers or others can enter, edit and manage the vendor-supplied data for their products and/or services in that standardized database structure and then publish that data or a subset of that data to the appropriate physical location on a server accessible over the World Wide Web, such as the EPDeS web site server or the vendor's own server.

The central or main web site and server are referred to for clarity as the EPDeS (Electronic Product Design System) web site and server, respectively. The EPDeS web site and server function as an interface between vendor databases and EDA tools located at the user workstations. However, the EPDeS web site and server can be any suitable facilities, such as a standalone computer, and are not to be limited to the specific embodiments of the present invention. Likewise, the system is not limited to the design of electronic products.

Each vendor database is associated with a specific URL and each URL is held in a registry database. The vendor database structure is set up so that a separate URL is created for each product or service to be searched and/or compared. The vendor-supplied data can be held on a vendor server or another party's server or on the EPDeS web site server. Whether the vendor database is located at the vendor server or the EPDeS web site, the vendor can manage and control access to its vendor database, or delegate that authority to a central administrator at the EPDeS web site or another party.

The vendor database holds vendor-supplied data relating to materials/processes supplied by the vendor. The vendor databases retain the vendor-supplied data in a standardized database format at known URL locations. The vendor-supplied data held in the vendor databases can be searched via a web browser located at the user workstation which accesses a search engine capable of searching on multiple data fields in a logical fashion.

Any authorized user can log onto the EPDeS web site with an ordinary web browser. During that log-in process, the authorized user contact information is captured, within the scope of privacy laws. After the user has logged onto the web site, search criteria can be set up using one or more search query screen(s). A registry database can be provided and is created and managed by the EPDeS web site to hold selected information about each vendor database URL on the system. If a registry database is provided, the searching engine first conducts a preliminary search of the registry database based upon the search criteria and identifies a list of vendor database URLs to further search on.

After searching amongst data at the registry database and identifying vendor database URLs, the search engine then goes to those identified URLs to complete the search. The search engine locates the vendor(s) and/or data of interest using a simple or complicated search criterion. After that data is located in the vendor databases, the data results are presented to the user at the user workstation and the user can view and compare the results from one or multiple vendors, materials and/or processes.

Once the data results are made available on the screen, the user has several options. First, the user can select one or more of the sets of data results and download that information or a subset of that information directly to the user's workstation in a standardized format. The downloaded data, called vendor-supplied data, is saved in a vendor-supplied database at the workstation. Second, the user can view either text data, graphical data, audio clips and/or video clips from or related to the selected vendor-supplied data. And third, the user can make contact with the appropriate vendor expert via telephone, email or other means to answer specific technical, sales and/or business questions. The user can, for example, also modify the search criteria, re-start the search process, send the search criteria to another person electronically or save the search criteria for later use.

At any time after data results are made available to the user, the vendor-supplied data can be downloaded from the vendor database into the user's workstation. Since the vendor-supplied data is provided in a standardized format that is usable by any properly enabled EDA design tool, the vendor-supplied data can then be imported from the vendor-supplied database directly into any desired EDA design tool. The import can be achieved with either import software supplied at the EPDeS web site or elsewhere or by virtue of the import features made available by the EDA tool vendors.

There are two preferred techniques for importing vendor-supplied data into an EDA tool: direct import and using a Neutral Dynamic Hub. Direct import is used to initially transfer vendor-supplied data to the user's workstation. The vendor-supplied data can exist in a location that is accessible by the EDA tool, such as at the vendor or EPDeS web site or on the workstation or the workstation's network. The EDA tool includes an import feature that imports the desired vendor-supplied data directly into the EDA tool. Each EDA tool has an internal database (or uses one or more appropriate external databases) based on the needs of that particular EDA tool. For instance, a mechanical EDA tool is only interested in data which is associated with the mechanical portion of the design, whereas an electromagnetic analysis tool is only interested in data which is used in the electromagnetic design and analysis of the design. Accordingly, the EDA tool retrieves additional needed information from it's own internal database and only imports the vendor-supplied data from the vendor-supplied database which it uses in a particular design or analysis process.

The system of the present invention is also configured to provide a Neutral Dynamic Hub which allows for EDA design files and vendor-supplied data to be seamlessly transported from any EDA tool platform to any other EDA tool platform, while keeping data integrity. As each EDA tool operates on vendor-supplied data, it creates a design file. The Neutral Dynamic Hub allows for vendor-supplied data and design files to be transferred between various EDA tools, such as from a first EDA tool to a second EDA tool and then to a third EDA tool or back to the first EDA tool. The Neutral Dynamic Hub keeps the integrity of the design file and data intact as the design file moves from one EDA tool platform to another.

For example, if a product designer (or workstation user) starts with a mechanical design EDA tool which we can call M and uses a certain set of vendor-supplied material data, only those material properties which are associated with the internal or external database of that particular mechanical design tool is imported into tool M from the vendor-supplied database. The EDA tool M creates a mechanical design file that is saved to the user's workstation or workstation network. If the workstation user then wants to take that mechanical design file and transport it to an electromagnetic design tool E, the mechanical data is stripped away during the transfer process into the Neutral Dynamic Hub, if used, from M to E and the vendor-supplied data which E needs for its internal database is added to the transported design file data.

In the embodiment in which the Neutral Dynamic Hub is used, the desired vendor-supplied data is first imported into the Neutral Dynamic Hub file. For example, if a certain type of ceramic material is used to build a substrate that is being designed, then the vendor-supplied data for that particular ceramic material is imported into the Neutral Dynamic Hub. The vendor-supplied data can be obtained from either the vendor-supplied database at the workstation or from any accessible location. If the product designer starts the design process with a mechanical design tool, then the mechanical data properties for that ceramic material is brought into the mechanical design tool via the Neutral Dynamic Hub.

If the mechanical design file is desired to be sent to an electromagnetic design tool, then the mechanical EDA design file is brought into the Neutral Dynamic Hub and that file is then transported to the desired electromagnetic design tool. In that transport process, the transport process strips away the mechanical properties data from the mechanical design tool file and sends the appropriate materials data needed by the internal database of the electromagnetic tool. However, the integrity of the design file and vendor-supplied data is maintained by the Neutral Dynamic Hub so that the design file and vendor-supplied data can be later transferred from/to another EDA tool or back to a previous EDA tool. That process of bringing an EDA design file into the Neutral Dynamic Hub can be repeated any number of times, each time the appropriate design file data is stripped away from the source file and the appropriate vendor-supplied data is added to the destination file.

The Neutral Dynamic Hub also translates an EDA design file so that all or most of its attributes can be readily transported from any source file to any destination file. The source file is converted from the format structure for the source EDA tool to a neutral file structure, and then from the neutral file structure to the format structure for the destination EDA tool. The Neutral Dynamic Hub can also transfer vendor-supplied data into and between EDA tools. That concept of using the Neutral Dynamic Hub is one method of implementing CAD File Transportability, though other methods can be used such as point-to-point (EDA tool-to-EDA tool) transportability without using the Neutral Dynamic Hub. However, design files and vendor-supplied data can be transferred in any suitable manner and need not be transferred by direct import or the Neutral Dynamic Hub. One example of the technique of CAD File Transportability is illustrated in U.S. Pat. No. 5,903,886 to Heimlich. The adaptive state machine disclosed therein can be used to implement one version or method of the Neutral Dynamic Hub.

If there are any changes made to the mechanical design layout in the E design tool, those changes are reflected in the design file which is transported back to the mechanical design tool, if and when that design file gets transported back to the M design tool. In addition, the electro-magnetic vendor-supplied data is removed and the mechanical material properties are added to the data which is then imported back into the mechanical design tool. Thus, for instance, although the electromagnetic vendor-supplied data is removed from the design file, the influence of that data may be reflected in other data of the transferred design file.

The system of the present invention fundamentally reduces the time to market, reduces the cost and improves performance by facilitating communication of complex information between designers/buyers and vendors/sellers which reduces errors and enhances commerce between the levels of the supply chain. The system provides an interface between all levels of the supply chain, such as product designers and vendors, and contains reliable materials data, component data, models and manufacturing process and testing data. The system also allows for the seamless transfer of vendor-supplied data and design files between EDA tools. The present invention further provides a seamless transfer of EDA files from one EDA tool platform to another, including the sharing of data and files from/to designers and vendors (or buyers and sellers).

One advantage of implementing the system on the Internet is that additional materials data, process data and models and other information can be acquired, and designer-vendor communications are advanced. The testing methods and standards that are used to test certain properties are preferably indicated so that materials and process characteristics are accurately represented in the vendor databases. The system also uses a standardized database structure for models and process data which interface with the various EDA tools.

Service providers benefit from the present invention since they can acquire new devices at lower cost and in substantially less time. That has a direct financial impact by lowering costs and allows new devices to be brought more quickly to market. Equipment makers also benefit from the present invention since they can design products faster and with fewer iterations, requiring fewer engineers to accomplish more successful designs more quickly. The net effect is that manufacturers and designers, such as wireless equipment makers and others at all levels of the supply chain, can satisfy their customers and/or other supply chain members with lower costs as well as with devices brought to market more quickly than ever before.

Because the system of the present invention allows for a wide array of vendor-supplied data to be made available to an entire supply chain, EDA tool vendors can use that data to address a wider array of engineering problems than before with limited supplier data, both up and down the supply chain, and therefore have a larger marketplace. Vendors at all levels of the supply chain can bring a new material, component or manufacturing process to market more quickly and easily by making the right information available to the designer or other supply chain members who need it, and at the time a supply chain participant needs it.

The detailed materials, process, component and model or other information is available to the entire supply chain universe with just a few mouse clicks. Once received, that information works directly in the design tool system and provides the user with the ultimate opportunity to perform tradeoff analysis and design changes quickly, easily and accurately, without the miscommunication common with today's sales process, where much of the complex information is communicated manually, rather than by direct electronic transfer. The use of such a product design system provides those vendors with a significant competitive edge, since their data is electronically transferred and usable by the persons who need it—the designer, supplier, or any other participant in the supply chain.

Ultimately, the consumer benefits due to the ability to have the products that they want, at a lower price. These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a block diagram of the overall product design system of the present invention in accordance with the preferred embodiment of the invention;

FIG. 2 is a detailed diagram of a workstation used in the product design system;

FIG. 3 is a representation of the Neutral Dynamic Hub used with the present invention;

FIG. 4 is a flow chart showing the overall operation of the product design system of the present invention;

FIGS. 5-7 illustrate a material vendor database; and

FIG. 8 is an illustration of the data required for internal databases of different EDA tools.

FIG. 9 is an illustration of search results used in an example of the invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

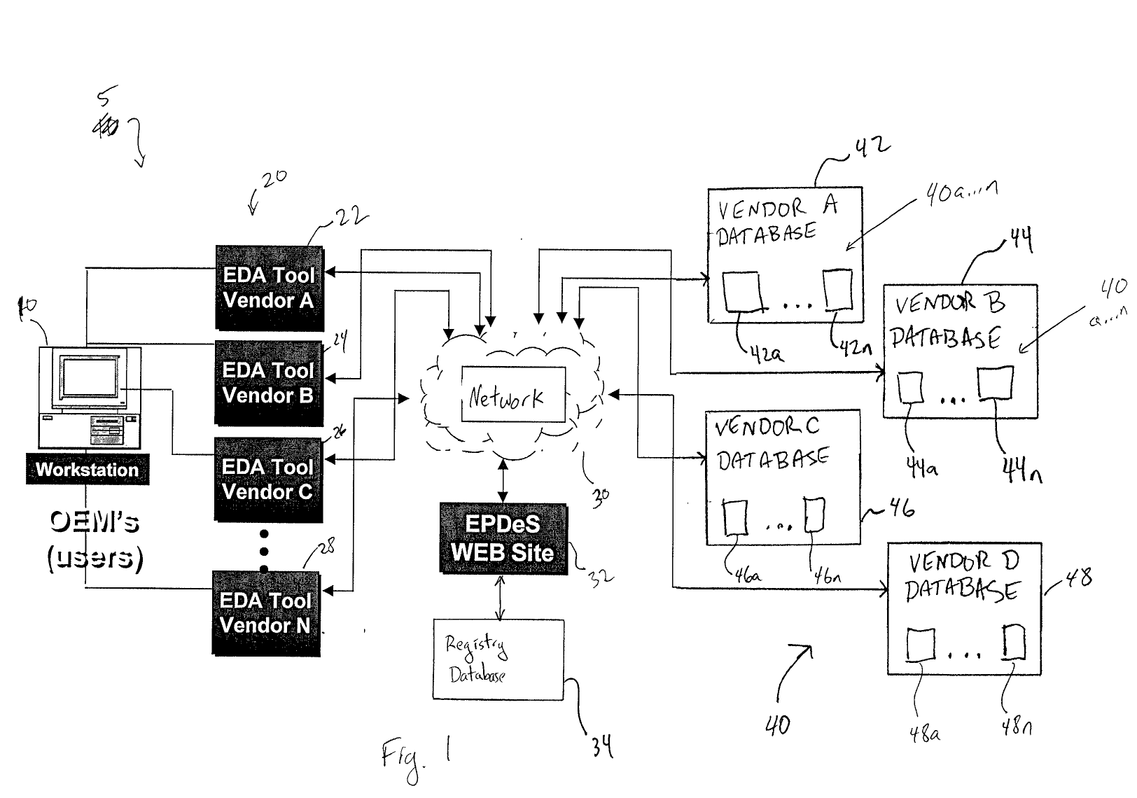

Turning to the drawings, FIG. 1 shows the product design system 5 in accordance with the present invention. The system 5 primarily has a workstation 10 that is used to access one or more remotely located vendor databases 40 via a network 30. The network 30 can be a local or private network, either an inter- or intra-network, though it is preferably a global network such as the Internet. The workstation 10 can access the remote vendor databases 40 directly or through an accessible central system web site 32. Alternatively, the vendor databases 40 and central system web site 32 can be located locally at the user's workstation or the user's local network.

Each vendor database 42, 44, 46, 48 provides vendor-supplied data for a different vendor in accordance with one or more standardized database structures. The vendor databases 40 can each contain one or more files 40a . . . n of vendor-supplied data, each vendor data file 40a . . . n associated with a specific material, component, product, model, design rule, set of design rules or process, depending upon the particular products or services provided by that vendor. Preferably, a single standardized format is used for each file type, though more than one format can also be defined.

Thus, for instance, vendor database 42 for a first vendor can have a first file 42a for a first material, a second file 42b for a second material and a third file 42c for a first component. Assuming the first and second materials are similar, the first and second files 42a, 42b preferably have a same standardized data structure. The third file 42c, however, preferably has a different standardized data structure since it holds vendor-supplied data relating to a component as opposed to the materials data held by the first and second files 42a, 42b.

Further to the present example, a second vendor database 44 can include a materials data file 44a, a design rules data file 44b, models data file 44c and a component data file 44d, which are accessed directly or through the central web site 32. Assuming the materials data file 44a is for a material that is similar to the first and second materials files 42a, 42b of the first vendor, the materials data file 44a preferably has a same standardized data structure as the first and second materials files 42a, 42b. The first and second vendor databases 42, 44 can contain more general information about the vendor. The vendor can control or limit access to any data at the vendor's database 40, either at the vendor's server or at the central web site 32, by requesting workstation users to have a user identification and password.

The first vendor database 42, as well as each vendor data file 42a . . . n is associated with a unique Universal Resource Locator (URL) or equivalent that is individually searchable. Thus, for instance, the vendor database 42 can have the URL http://www.vendor_name1.com/EPDeS_product_data and the first vendor data file 42a can have the URL=http://www.vendor_name1.com/EPDeS_product_data/product_{—}1_data and the second vendor data file 42b can, for instance, have the URL http://www.vendor_name1.com/EPDeS_product_data/product_{—}2_data and so forth. Accordingly, in the preferred embodiment, the vendor database 40 has a top level URL and the vendor data files have a URL at least one level deeper than the top level URL. Of course, any suitable method can be used to associate or link the workstation 10 or central web site 32 to the vendor databases 40 within the scope of the invention.

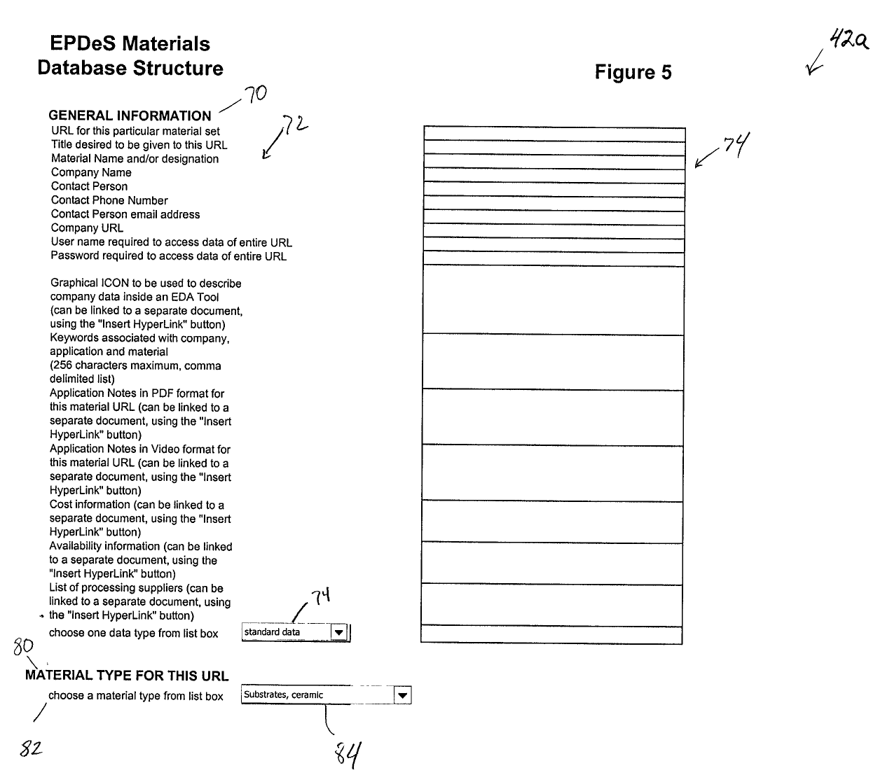

Accordingly, each URL represents a vendor data file 42a . . . n for a different material, model, design rule (as manufacturing specifications), components, or other information. The vendor data files include specific vendor-supplied data. A materials file 42a for a first vendor database 42 may contain values for a dielectric constant, thermal conductivity, and the like data, as further discussed below with respect to FIGS. 5-7. The vendor data files can contain other types of data linked to any of the specific data, such as application notes, other URLs, audio clips, video clips, and the like. The data can also be nested, such that the data relates to other data which in turn relates to other data, and so forth. Each vendor database 40 can be set up and managed by the vendor on their own server, other server or at the server used for the central web site 32.

Optionally, a registry database 34 is provided at the central web site 32. Once a vendor database 40 is associated with the EPDeS web site 32, the central web site 32 retrieves selected information from the vendor database 40 URL and/or the vendor data files 40a . . . n, and stores the retrieved information in the registry database 34. Preferably, the registry database 34 stores more general information about the vendor-supplied data located at the vendor database 40. For instance, the registry database 34 can contain selected information such as whether the vendor data files 40a . . . n of the vendor database 40 relate to a material, component, or process, the general type of material, component or process, and the vendor name. In addition, the registry database 34 can include the company name, zip code, certain management information such as their membership start and stop dates and accounting information, key words and other important selected information about that particular product or service which could be used to pre-select the search.

Workstation 10 is used by anyone seeking access to the vendor databases. For consistency and clarity, the phrase “workstation user” is used throughout to refer to any user of the workstation 10. The phrase workstation user is intended to include, for instance, a supplier, product designer, buyer, or any person in the supply chain wishing to gain access to vendor-supplied data or wishing to transport design files from one EDA design tool platform to another. The workstation 10 can be a standalone computer, or part of a global or local network.

During product development and design, the workstation user will likely use any number of different EDA (Electronic Design Automation) tools 20, such as a circuit design EDA tool 22, electromagnetic design and analysis tool 24, mechanical design tool 26, thermal design tool 28, and the like. Those tools 20 require that certain product specifications be entered by the workstation user in order to generate the desired design. For instance, depending on which EDA tool is being used, the workstation user may need to provide the EDA tool with whatever information is required by that particular EDA tool, such as electrical and/or mechanical component specifications, material properties, etc.

In order for the workstation user to obtain the necessary vendor-supplied data to enter in the EDA tool, the workstation user must select the vendor-supplied data of interest (such as, for instance, a certain ceramic material or set of design rules for a certain vendor) from the vendor databases 40. Accordingly, the workstation user formats a search for the desired information. Data can be searched based on a simple or complex set of search criteria, including but not limited to keywords, material(s) properties, design rules, models, components and/or vendors from any combination of data fields in any of the standardized database structures.

The search can include ranges, company information, geographical location, or any other information contained in the databases 40. Searches can be formatted in accordance with standard boolean operators, logical operators, arithmetic operators and functional operators. Keyword searching can be hierarchical or non-hierarchical and alternatives to keyword searching can also be provided, such as parametric or natural language searching.

The workstation user formats a search and enters search criteria into the central site 32 from the workstation 10. The web site 32 has a search engine that searches the vendor databases 40 for the desired information based upon the search criteria entered by the workstation user. If a registry database is provided, the searching engine first conducts a preliminary search of the registry database based upon the search criteria and identifies a list of vendor database 40 URLs to further search on. The search engine then goes to those identified URLs to complete the search by searching amongst the specific vendor-supplied data in the vendor data files 40a . . . n.

Hence, the search engine locates the vendor(s) and/or vendor-supplied data of interest using a simple or complicated search criterion. After that data is located in the vendor databases, the data results are presented to the user at the user workstation and the user can view and compare the results from one or multiple vendors, materials and/or processes. The results of the search are presented on the workstation screen in an organized and viewable fashion. At this point, the workstation user has several options, such as to either refine or edit the search, conduct a new search, electronically (such as over the Internet) send the search criteria to another person, investigate any of the located data to have access to some or all of that data, save the search criteria, or go somewhere else on the central site 32 or elsewhere.

The user can view either text data, graphical data, connect to vendor via network, enable voice and/or video and/or data communications, such as IP over phone connections, audio clips and/or video clips from or related to the selected vendor data file(s). Further, the user can make contact with the appropriate vendor expert identified in the search results via telephone, email or other means to answer specific technical, sales and/or business questions. The user can also modify the search criteria, re-start the search process, or save the search criteria for later use. In addition, the workstation user can select two or more sets of data files to be compared in various ways, using selected data fields of interest. For instance, the workstation user can compare certain properties of similar material from multiple suppliers, or can compare two different sets of design rules. Comparison criteria, as well as the actual data comparisons, can be saved for future use.

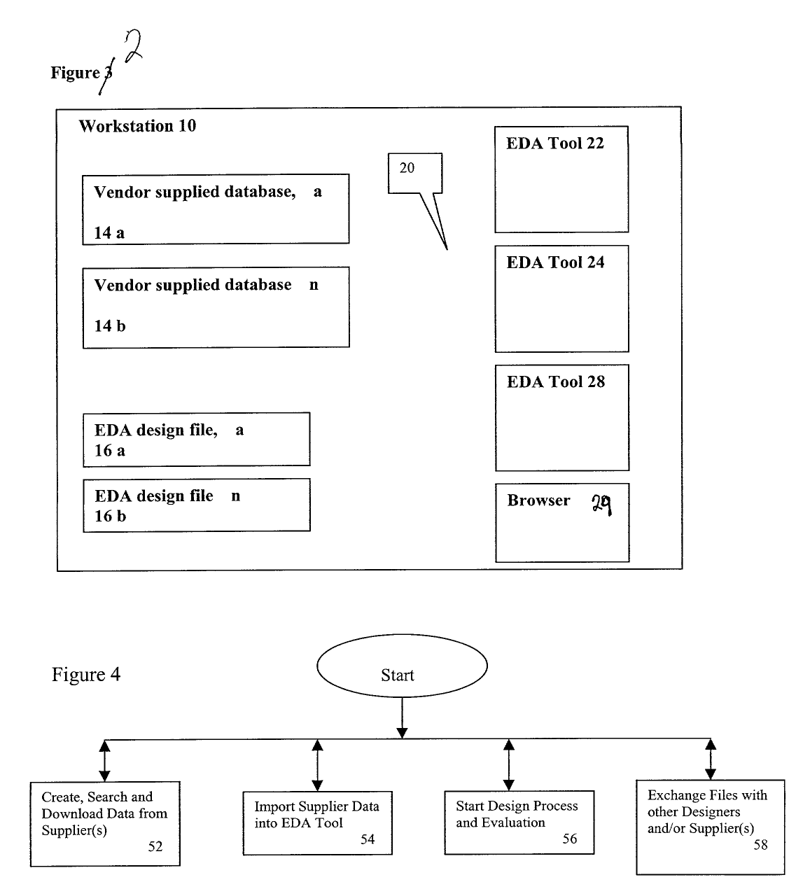

At any time after data results are made available to the user, the user can select to download all or a subset of one or more of the located vendor-supplied data from the vendor database 40 or vendor data files 40a . . . n into the user's workstation (FIG. 2). In addition, the vendor-supplied data that is downloaded can be regulated or limited by the vendor. The vendor-supplied data is provided in a standardized format that is usable by any EDA design tool that is properly enabled to recognize the standardized format or where a proper transport mechanism is provided, such as the Neutral Dynamic Hub. The vendor-supplied data can then be imported from the vendor-supplied database 14 into any desired EDA design tool. The import can be achieved with either import software supplied at the EPDeS web site or elsewhere by virtue of the import features made available by the EDA tool vendors.

In order to download located vendor-supplied data from the vendor database or vendor data file 40a . . . n, the workstation user proceeds to select one or more vendor data files 40a . . . n from the search results. A password is provided, controlled by the vendor or other designated entity, if password protection is enabled for the selected data. The selected vendor-supplied data or a subset therein, which is provided in a standardized database structure, is downloaded directly to the workstation 10, or other designated location, over the network 30. The downloaded vendor-supplied data, all or part, is stored in a vendor-supplied database 14a . . . n, and is then available to be used and can be imported by one or more of the EDA tools 20.

As further shown in FIG. 2, the workstation 10 includes one or more vendor-supplied databases 14a . . . n that are used to store vendor-supplied data retrieved from the vendor databases 40 and/or vendor data files 40a . . . n. The workstation 10 also includes one or more EDA design files 16a . . . n that are created by one or more of the EDA tools 20. The vendor-supplied databases 14a . . . n can be accessed by one or more of the EDA tools 20. For instance, using a graphical user interface, the vendor-supplied database icon can be dragged and dropped onto the EDA tool icon or EDA tool library file. The workstation user uses the EDA tools 20 to create EDA design files 16a, 16b. Each EDA design file 16a, 16b can be made up of one or more files to represent the files needed by a particular EDA tool 20, such as either EDA tool 22, EDA tool 24, or EDA tool 28.

The vendor supplied databases 14a, 14b can be imported directly into the EDA design tool 20, if those EDA tools have been properly enabled to import the standardized database data provided in vendor supplied databases 14a, 14b. Most EDA tools have built in libraries or access to external libraries. If the vendor supplied database 14 is placed in the appropriate directory for that particular EDA tool 20, and the EDA tool has been properly enabled to read the “standardized database structure,” then that particular EDA tool will be able to read the vendor supplied database data. Assuming the use of a graphical user interface in the workstation, a user can drag and drop the vendor supplied database icon onto the desired EDA tool or the desired EDA tool library file directory.

The design files 16a, 16b contain all of the information needed for a particular design, which was created by a particular EDA tool 20. Each EDA tool 20 creates its own EDA design file 16, containing one or a collection of files having all of the information that the particular EDA tool needs to view, print, transmit, analyze and/or manipulate that particular design. The workstation 10 also has a web browser 29 that is used to access the Internet, the World Wide Web or other network, if necessary to communicate with the central web site 32 and vendor databases 40. However, one or more of the vendor-supplied databases 14, EDA design files 16, EDA tools 20 and the browser 29 can be provided at a central location or distributed at locations throughout the network that is accessed by the workstation 10 such as for an Intranet or local network.

Once the standardized vendor-supplied data is downloaded from the vendor database 40 to the workstation, the data can be transported to any of the EDA tools 20. Preferably, there are at least two alternatives to transport the vendor-supplied data from the vendor-supplied databases 14 to the EDA tools 20, by direct import and using the Neutral Dynamic Hub. With the direct import technique, the vendor-supplied data exists in a location that is accessible by the EDA tool, such as at the vendor or EPDeS web site 32 or on the local workstation or on the local network or local intranet. The EDA tool includes an import feature that imports the needed vendor-supplied data directly into the EDA tool from the vendor database or if a graphical user interface is available, a user can drag and drop an icon representing the vendor-supplied data onto an appropriate spot in the EDA tool.

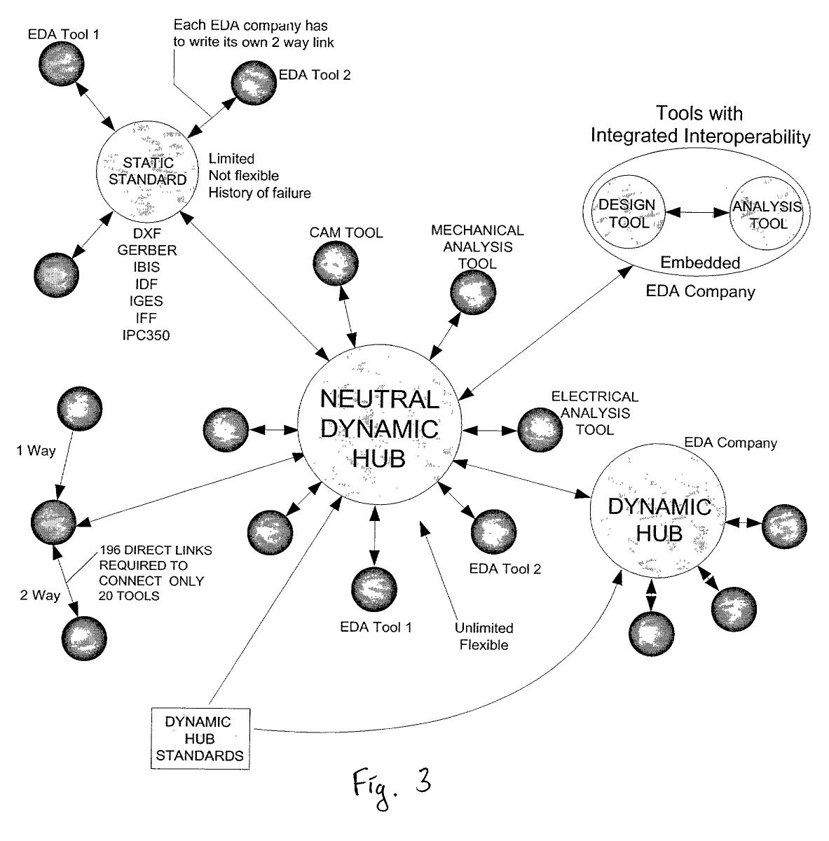

The Neutral Dynamic Hub is shown in FIG. 3. If a workstation user desires to move an EDA design file 16 from one EDA tool 20 to another EDA tool 20, that EDA design file 16 is first moved into the Neutral Dynamic Hub, then that EDA design file is moved out of the Neutral Dynamic Hub into the next EDA tool of choice. The Neutral Dynamic Hub holds all of the information about that EDA design file 16 and the data held in that file from the vendor-supplied data of vendor-supplied database 14 and maintains file and information relationships. Thus, as the EDA design file 16 is moved from the Neutral Dynamic Hub to the next EDA tool, the appropriate vendor-supplied data from the vendor-supplied database 14 is outputted by the Neutral Dynamic Hub and brought to the next EDA tool 20.

If the Neutral Dynamic Hub and its related software is present, operational or accessible on workstation 10, then the vendor supplied databases 14a, 14b are brought into the Neutral Dynamic Hub. When an EDA tool 20 desires data for a particular EDA design file 16a, 16b, the Neutral Dynamic Hub converts that standardized data from the vendor supplied databases 14a, 14b into the proper formats needed by any and each of the EDA tools 20.

The Neutral Dynamic Hub imports the standardized vendor-supplied data from the vendor-supplied database 14 and extracts a subset of data which is useful to that particular destination EDA tool. Database field names are converted from the standardized database to the database field names for the destination EDA tool. That vendor-supplied data is then sent to the destination workstation or EDA tool, which can be specified upon opening the Neutral Dynamic Hub session.

Once an EDA tool creates a design file 14, that design file 14 can be retained by the Neutral Dynamic Hub using predefined session settings such as the vendor-supplied database, specific EDA(s) tool being used, design files and the locations for all of those elements. With that information, the Neutral Dynamic Hub can keep track of which vendor databases are being used for the design and make available the subset of data needed for the next EDA tool in the design process.

The Neutral Dynamic Hub, if used, can be resident either at the EPDeS web site 32 on the workstation 10 or at any other suitable location on the (public or private) network. If the Neutral Dynamic Hub is located at the workstation 10, the standardized vendor-supplied data is downloaded to the workstation 10. The downloaded data is brought into the Neutral Dynamic Hub for use by any of the EDA tools of choice.

The Neutral Dynamic Hub provides a file transport converter that converts an EDA file format from one EDA tool platform to another EDA platform file format. The file transport converter maintains the file and data integrity as the file is moved between a first EDA tool platform to a second EDA tool platform and back to the first EDA platform again, as desired by the workstation user. Though either or both of the direct import and Neutral Dynamic Hub techniques may be used in the preferred embodiment, any suitable file transport system can be used. The Neutral Dynamic Hub is neutral since the company that writes the transportability software is not necessarily the CAE, CAD or CAM company. The Neutral Dynamic Hub is dynamic because the data format can change based on the real time needs of the design process. A static hub and a dynamic hub are also shown in FIG. 3, as well as tools with integrated interoperability that might not need design files to be translated by the Neutral Dynamic Hub.

Operation of the system 5 will now be discussed with reference to FIG. 4. As noted above, the system 5 has four primary operations, each of which can operate simultaneously and are not necessarily performed in sequence. In addition, those operations are enabled once one or more vendor databases 40 have been created. A workstation user located at workstation 10 can access the central site 32 at step 52, by opening a conventional web browser 29, or using a web browser 29 feature from within any other software application, and accessing the central site 32 via the network 30, which can be the Internet or an intranet.

The workstation user may or may not be required to have a user ID and password in order to gain access to the central web site 32. After the workstation user accesses the central web site 32, the workstation user can set up a new or retrieve a previously set up search criteria. Once that search criteria is identified, the search engine locates the best match from the vendor databases 40 for the criteria identified. Optionally, the search engine can first conduct a preliminary search of the registry database to initially narrow the number of vendor databases 40 that need to be searched. The vendor has control over what data can be viewed and downloaded. Some vendor-supplied data can be designed as public data so that no password is needed to view or download that data. In some cases, the vendor can require a user ID and password in order to view and/or download non-public data of the vendor-supplied data. The vendor further has the option of restricting access to all or part of any data contained within its vendor databases 40 based upon information submitted by the workstation user to obtain the user ID.

Once the workstation user gains access to the website 32, the user formulates a search for materials or processes or models or components or the like which meet the needs of the user. The search can include any limitations necessary to the product or process being designed, such as for instance, field restrictions based upon vendor, price, weight and size based upon any combination of data fields held in the vendor database. The website 32 includes a search engine which searches one or more of the vendor databases 40. The vendor databases 40 that are searched by the website 32 depend upon any database selections made by the workstation user and the particular search requested.

If, for example, the search is for circuit elements, the search might exclude a particular vendor known to have a materials database 42 and/or a models database 46. The search can also exclude, for instance, a materials vendor data file 44a within a vendor database 44, though include a circuit vendor data file 44b within that same vendor database 44. Since the data located in the vendor databases 40 is provided in one or more known standardized database structures, a single search can include a plurality of the vendor databases 40.

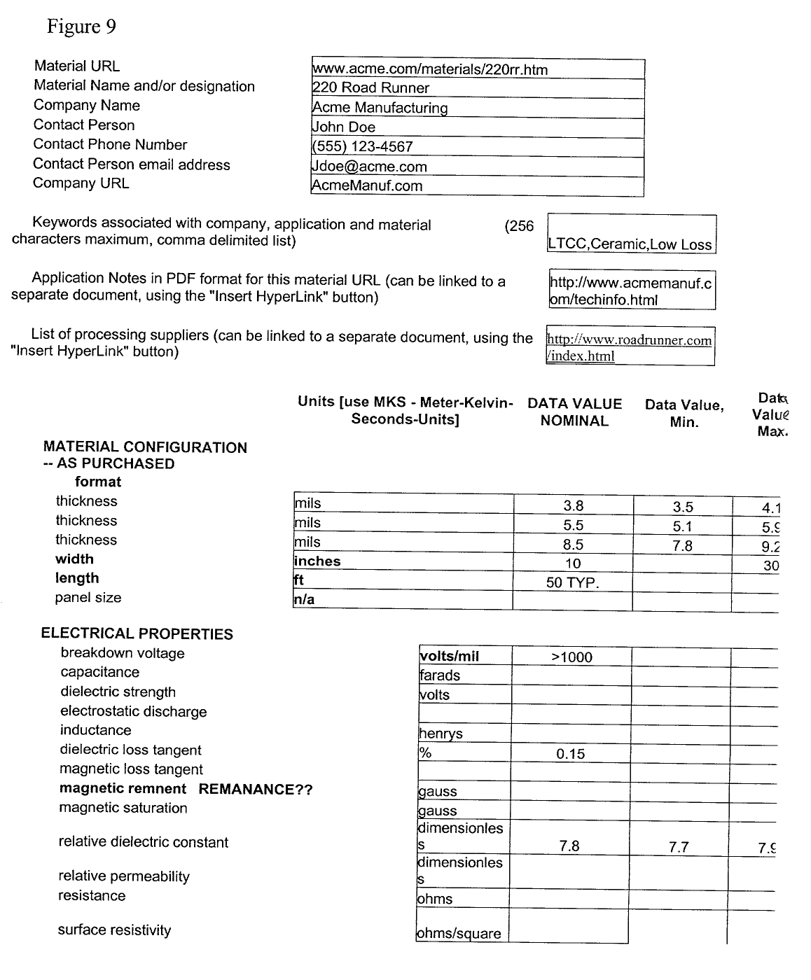

The results of the search are displayed to the workstation user in a list or arranged into organized views. For example, a workstation user can conduct a search for a material type such as ceramic LTCC (low temperature co-fired ceramic), dielectric constant of 7.8 and an operating temperature of 23 degrees Celsius. The search criteria can be formatted as: ceramic AND LTCC AND dc/7.8 AND t/23, where dc/ searches the dielectric constant field and t/ searches the temperature field. Sample results for that search are shown in FIG. 9. The search terms ceramic and LTCC were found in the keyword field and the appropriate dielectric constant and operating temperature were located in the respective fields.

If a registry database 34 is being used, the search engine might look for the terms “ceramic” and “LTCC” in the registry database 34 to identify vendor databases that meet those general criteria. The located vendor-databases would then be more fully searched for the terms 7.8 in the dielectric constant field, and 23 in the temperature field.

Once the search results are displayed, the workstation user can select to view additional information by clicking on one of the displayed results. If proper password protection is available to the workstation user, the located vendor-supplied data can also be downloaded from the databases 40 to the workstation 10 or other suitable location, where it is saved as a vendor-supplied database 14a. The vendor can limit the vendor-supplied data which the user is able to download to the workstation based on the user's access level and for security reasons. Additionally, the workstation user can limit the vendor-supplied data that is downloaded to the workstation based upon the user's needs. The vendor-supplied data also identifies one or more specific URLs. When a URL is selected by the workstation user, the data located at that URL can also be downloaded from within the vendor databases 40 to the workstation 10.

The vendor-supplied data can be retrieved from the vendor-supplied database 14a and imported into any of the EDA tools 20, at step 54. Since the data stored in the vendor-supplied database 14a is in a standardized database structure, it can be utilized by the different internal database structures for each of the different EDA tools 20. That eliminates errors that might otherwise occur by manually entering data into the EDA tool 20 and which lead to design and prototype errors.

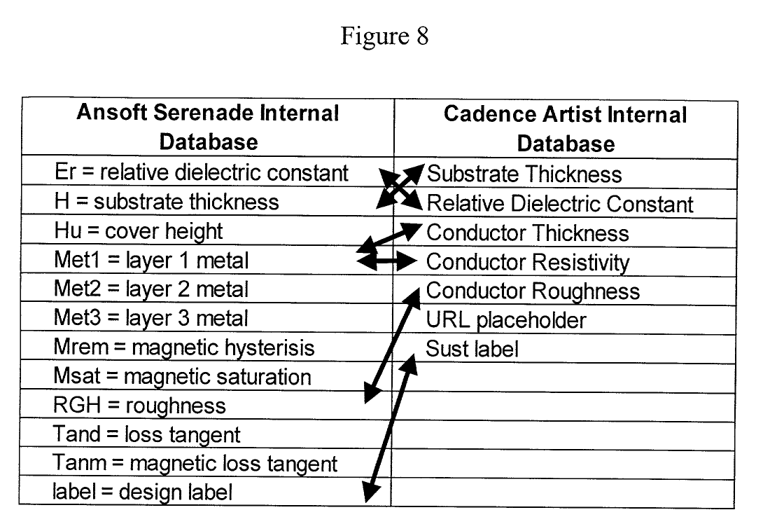

Different EDA tools 20 have different internal databases. FIG. 8 is a side-by-side comparison of two exemplary EDA tool databases, Ansoft Serenade and Cadence Artist. The Ansoft program is a schematic capture and RF simulation tool and the Cadence program is an analog mixed signal schematic capture tool. The two databases require information about the substrate thickness, relative dielectric constant, conductor thickness, conductor resistivity, conductor roughness and label. It should be noted that those properties are designated differently in each database. In addition, the Ansoft program requires information about other material properties that are not required by the Cadence tool, and vice versa. For instance, the Ansoft program requires information about the cover height, loss tangent and magnetic saturation and hysterisis, which is not necessary for the Cadence tool.

Accordingly, each tool 20 can import the data from the vendor-supplied database 14a that is necessary for that tool to perform the desired calculations and data manipulations. The vendor-supplied database 14 provides the information to the tool 20 in a standardized database structure format, so that the different tools 20 can import the information which is necessary and needed for that particular tool to do its job. In the example of FIG. 8, for instance, the Ansoft program will recognize information from the vendor-supplied database 14 as the Met1 (layer 1 metal), whereas the Cadence tool will recognize that same information to be the conductor thickness.

There are at least two alternative preferred techniques for importing the vendor-supplied data into an EDA tool. The EDA tool can be enabled to recognize and be able to import the required data from the standardized database. Alternatively, the supplier data can be brought into the Neutral Dynamic Hub. In that manner, the appropriate vendor-supplied data can be moved into the internal database of the EDA tool of interest.

At step 56, the workstation user can start the design process and evaluate the effect that a different material, model, manufacturing process and/or component has on the product design, using each of the EDA tools 20. For instance, the workstation user can select to use the circuit design EDA tool 22 to analyze RF circuit response based upon material information obtained from a particular vendor-supplied database 14. The workstation user can also evaluate the same or similar materials obtained from different vendor databases 40 in order to determine the optimal material and vendor for the overall product design. Thus, for instance, a workstation user can evaluate different types of insulator materials from different vendors for use in a particular product design.

The circuit design EDA tool 22 creates an EDA design file or a collection of design files that are saved either at the workstation 10 or in some other part of the workstation's network. The workstation user has the option to exchange EDA design files 16 and/or vendor-supplied database files 14 with other workstation users working on different aspects of the product design and/or with one or more suppliers, at step 58. For instance, an RF circuit response EDA design file 16 from a particular EDA tool 20 can be sent to a materials vendor who then imports the file 16 into an EDA tool 24 for further design review and analysis, even though the EDA design file 16 may have been created on a different EDA tool than the EDA tool 24 used by the material supplier.

The vendor-supplied database(s) 14 and the EDA design file(s) 16 can be transmitted via the Internet or intranet. Since the vendor-supplied database(s) 14 have a standardized database structure format, the files can be transmitted to other vendors and/or workstation users located at different workstations 10 for use with their respective EDA tools. Accordingly, a plurality of workstations 10 can be provided, each having one or more EDA tools 20 that are used by a specific type of workstation user. Furthermore, the system 5 eliminates the need for manually re-entering information, and instead information can easily be shared between different EDA tools 20. Each workstation user is able to work with the same reliable data.

For instance, the workstation user can download information from a particular vendor database 40 into the vendor-supplied database 14a. The retrieved data is imported from the vendor-supplied database 14a into a first circuit design tool 22, such as Ansoft Serenade, which evaluates the RF circuit response for a single set of materials data for each of the elements in the design. The data results of the first circuit design tool 22 are stored in the EDA design file 16a. Accordingly, a first circuit analysis can be performed for a material obtained from a first vendor to obtain a first design file 16a and a second circuit analysis can be performed for a material obtained from a second vendor to obtain a second design file 16b. The design files 16a and 16b can then be compared.

Continuing with the present example, one (or both) of the two design files 16a, 16b can then be transmitted to a second vendor (for instance, a materials vendor), for design review either at a same workstation or a remote workstation. The materials vendor can open the design files 16a, 16b, which were created with the first tool (Ansoft Serenade), into a second tool, such as Cadence Artist. The second tool can obtain any additional information needed to complete a design that was not needed by the first tool by importing information from the vendor-supplied databases 14a, 14b. If necessary, the information can be transferred from the first tool to the second tool and back through the Neutral Dynamic Hub. The materials vendor can make design suggestions to the design file 16a, 16b and transmit the design file back to the OEM workstation user. The workstation user can import the design file, which was modified by the second tool, back into the first tool (Ansoft Serenade).

The design file can also be transmitted to the board layout department, which for instance can use a third tool such as Mentor Graphics Design Architect to capture the board schematics. The board layout department can then evaluate the design and prepare to do a physical design.

The design file can then be transmitted to the circuit layout department, which then uses a fourth tool such as Agilent ADS to conduct circuit and system simulation, electromagnetic analysis, physical layout and synthesis inspections. The circuit layout department could work on a filter design and complete a board auto layout of the circuit.

As a final step of the present example, the circuit layout department can send the design file to a contract assembly house. For example, the contract assembly house may use a fifth tool, such as CAD Design Software's (CDS's) EPD Tool, to review the file and click on a URL which is Internet-enabled within the design file which, if the workstation is connected to the Internet, will take the user out to that URL on the Internet or other network to answer questions about how to handle and process the material.

As a next example of the overall operation of the system, suppose that a mechanical designer is working on designing a new product. The mechanical designer first wishes to evaluate a number of materials used in the mechanical design process. Accordingly, the designer points his/her browser 29 to the EPDeS web site 32 and conducts a search for materials that meet his/her needs. As a result of the search, the mechanical designer locates several materials from different suppliers, each of which meets his needs. The mechanical designer proceeds to download the vendor-supplied data from the vendor data files 40a . . . n at the vendor databases 40, and each material is downloaded into a different vendor-supplied database 14a . . . n.

The vendor can regulate or limit the vendor-supplied data that the user can download to the workstation 10, such as by use of the user password or by a filter based on, for example, user profile. Thus, for instance, the vendor can restrict or modify the vendor-supplied data to accommodate different purchasers or users. Accordingly, the vendor-supplied database 14a . . . n need not contain the entire vendor-supplied data provided in the vendor files 40a . . . n, and instead can be a subset of the vendor files 40a . . . n.

The mechanical designer can choose to start the design with a mechanical EDA design tool 26. The vendor-supplied data for the first material is retrieved from the vendor-supplied database 14a and imported into the EDA design tool 26. The mechanical designer conducts an analysis based upon the first material and saves the results in a first design file 16a. The mechanical designer can then analyze the results of that design on the second material. Accordingly, the vendor-supplied data for the second material is retrieved from the vendor-supplied database 14b and imported into the EDA design tool 26. The mechanical designer conducts the second analysis based upon the second material and saves the results in a second design file 16b. The mechanical designer can then compare the results of that first and second materials on the design by using the data stored in design files 16a, 16b using the EDA tool 26.

At this point, it might become clear to the mechanical designer that the second material is preferable to the first material, but that certain changes are needed to the actual product design. Accordingly, the mechanical designer may decide to determine what effect those changes have on the overall electrical and electromagnetic design of the product. Hence, the mechanical designer wishes to pass the design to an electrical designer who uses an electrical EDA tool 22. The mechanical designer uses the mechanical EDA design tool 26 to transport the EDA design file 16b and the vendor-supplied database 14b through the Neutral Dynamic Hub to the workstation 10 of the electrical designer.

It is noted that if the Neutral Dynamic Hub or an equivalent capability is not used, the EDA design file 16b created by the mechanical design tool 26 may not be directly read by the electrical design tool 22 without manual reentry of the design unless there already exists a means for mechanical tool 26 to import/export files to/from electrical tool 22. However, the standardized data in the vendor-supplied database 14b can be read into the mechanical and electrical EDA tools by other means.

The electrical designer uses the electrical design tool 22 to open the EDA design file 16b. The EDA design file 16b provides as many of the appropriate design attributes from the mechanical EDA tool 26, which are displayed by the electrical EDA design tool 22. Any further data needed by the electrical EDA tool 22 is imported from the vendor-supplied database 14b. The electrical designer conducts an electrical analysis of the design, using the electrical EDA design tool 22 and the set of materials data provided by the vendor-supplied database 14b. The information is stored as a new design file 16c.

At this point, there may still be some questions as to the manufacturability of the product design using the second material, whose properties are described in the vendor-supplied database 14b. Hence, the electrical designer can send (by Internet, for instance) the EDA design file 16c to the second vendor who supplied the data in the vendor-supplied database 14b. For illustrative purposes, assume that the vendor does not use the same EDA tool as the electrical designer. The design file 16c and vendor-supplied database 14b are transmitted to the second vendor via the Neutral Dynamic Hub. The second vendor then opens the design file 16c in the different EDA tool.

The vendor can do an evaluation of the design and make some specific suggestions by manipulating the design. Accordingly, the second vendor saves the design as a new design file 16d and sends the design file 16d back to the electrical designer. The electrical designer opens the EDA design file 16d in the electrical EDA tool 22 and reads and/or manipulates the file as modified by the second vendor.

Now assume that the design file 16d (and vendor-supplied database 14b) is transmitted from either the electrical designer or the second vendor back to the mechanical designer. At the time the mechanical designer originally sent the design file 16b to the electrical designer, the electrical EDA tool 22 dropped data from the design file 16b that was not needed by the electrical EDA tool 22, but was included in the design file 16b since the data was used by the mechanical EDA tool 26. Accordingly, the mechanical design tool 26 has to retrieve the needed vendor-supplied data from the vendor-supplied database 14b. In this manner, the mechanical EDA tool 26 only receives the new design from the design file 16d, so that the mechanical tool 26 does not confuse the new design with previous design data.

Once the design is finished, all of the materials specifications for that design are now part of that design's bill of materials and can be used by any other person in the purchasing, evaluation, manufacturing, etc. of the product process. The net result is a significant reduction in errors that are otherwise due to manual re-entry of designs and/or data. Those reduced errors allow for fast and easy evaluation of materials, models, components and design rules permitting faster designs with fewer errors and much higher first pass yields.

Since the system 5 permits workstation users to immediately access vendor data at databases 40, the time required to learn about new materials, models, manufacturing processes, design rules and/or components is substantially reduced. In addition, the workstation user can rapidly collect and evaluate accurate information to create a new design, so that fewer design iterations are required. Data errors and the design cycle are substantially reduced. The system also uses standardized databases for materials, models, manufacturing processes, design rules and/or components. Thus, data supplied at the databases 40 is accessible by different EDA tools 20. The product design system website 32 operates as a portal to bring together vendors and designers or buyers and sellers or any other interested party.

Accordingly, OEMs decrease the time needed to bring a new product to market. The workstation user is at the center of the design process and not at the mercy of the EDA tool supplier, who generally form a captive design environment which does not easily permit the designer to use other design tools in order to accomplish other design tasks outside of their particular and controlled EDA tool environment. OEMs can conduct rapid comparisons of vendors and vendor products to take advantage of lowest available production costs, time to market and newest technological advances. Products can be designed and built faster and at lower manufacturing costs. More accurate materials and manufacturing data provides higher first-pass manufacturing yields and faster time to market. Vendors, on the other hand, lower marketing, sales and support costs.

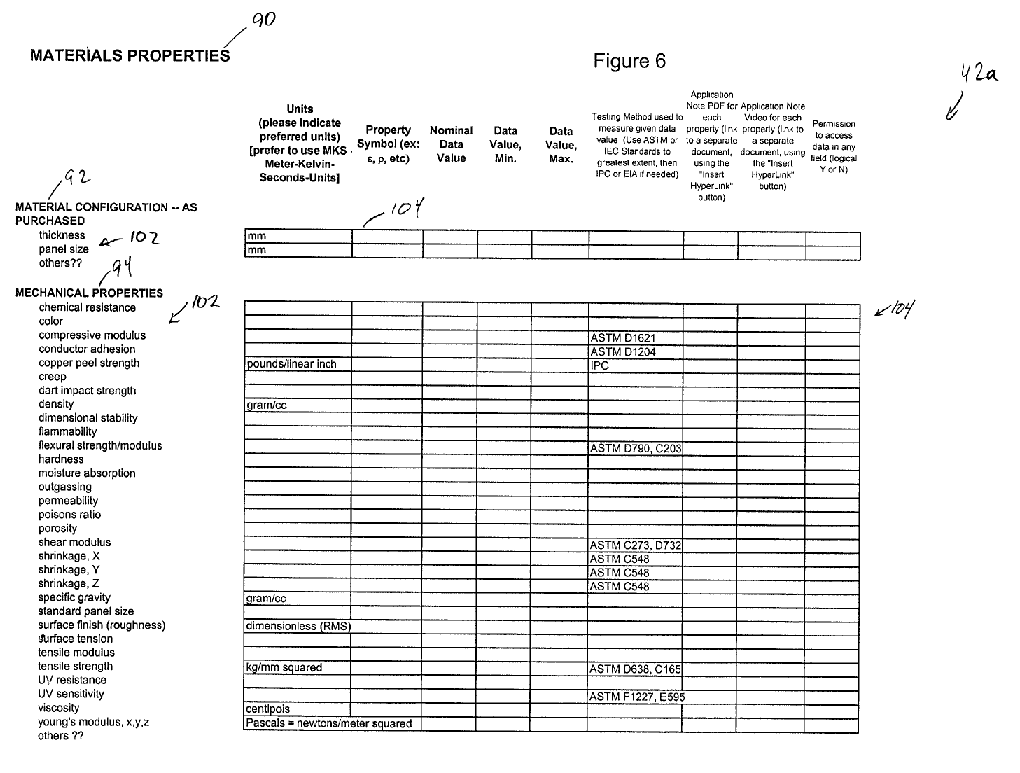

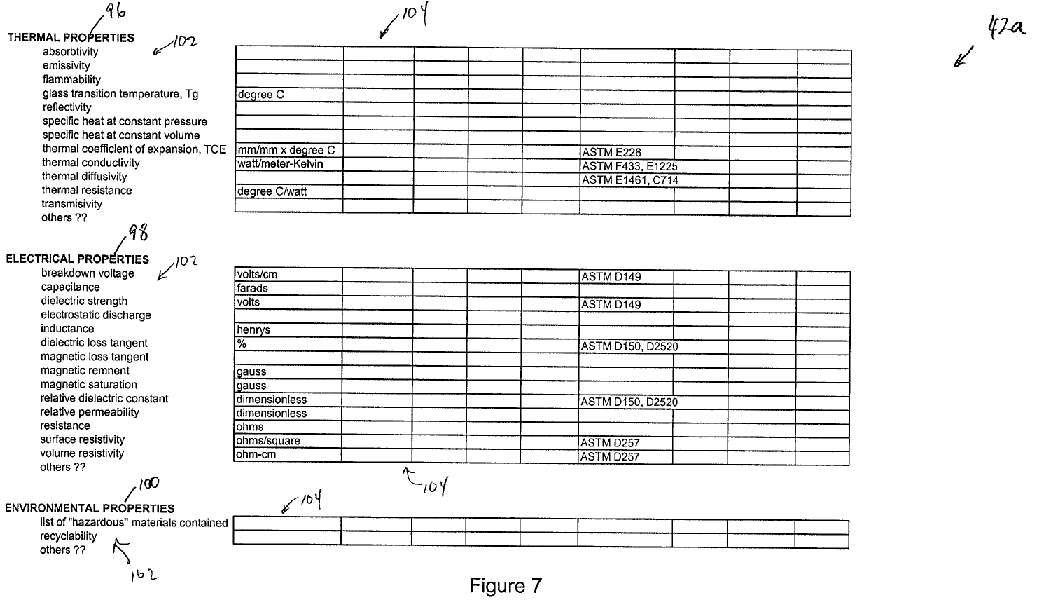

A material data file 42a is shown for a first vendor database 42 for illustrative purposes in FIGS. 5-7. The data file 42a generally has three categories, General Information 70 (FIG. 5), Material Type 80 (FIG. 5) and Material Properties 90 (FIGS. 6-7). The Material Properties category 90 is further divided into sub-categories or sections, shown here as Material Configuration 92, Mechanical Properties 94, Thermal Properties 96, Electrical Properties 98 and Environmental Properties 100. All of the categories 70, 80, 90 have at least one element title 72, 82, 92, 102 and a corresponding data element entry 74, 84, 94, 104.

Data is entered into the data element entry 74, 84, 94, 104 of the database 14 either by data entry or by a pull-down menu such as shown for selecting the data type 74. Data entry can be achieved through direct data entry or through the use of a wizard or other program that prompts the user to enter data for each data element 74, 84, 94, 104. The database 42 preferably provides all data elements that are used by the various EDA tools 20 and those elements which may be desired to be searched, and data can be input as fixed or floating point integers, a table of values, a (complex) function, and executable program and/or text. Data elements 74 can also be provided in different formats, such as .pdf, .html, audio clips, video clips, URLs and the like.

As shown in the General Information category 70, the vendor indicates general information about the vendor and the data provided in the materials data file 42a. Here, certain of the information, such as URL, User name and password, is preferably reserved for use by the system administrator and need not be provided by the vendor. There is at least one data element 74 for every element title 72. However, more than one data element 74 can be provided for each element title 72. For instance, the vendor can enter more than one contact as the data element 74 for entry title “Contact Person”, and likewise for the Contact Phone Number and Contact Person email address. Those data elements 74 can also be linked, so that if more than one Contact Person is listed, that entry is associated with the corresponding Contact Phone Number and Contact Person email address.

The General Information category 70 also is where the vendor indicates the Material Name and/or Designation 72. However, the Material Name and/or Designation can instead be listed under a different category, such as Material Type 80 or Material Properties 90. The vendor also indicates in the General Information category 70 whether the data provided is standard, custom or special data.

Turning to the Material Type category 80, the vendor indicates the general type of the material, such as adhesive, conductor, dielectric, electro-active, heatsink, lead/frame, plastic package, radome, resistor, ceramic substrate, flexible substrate, metal substrate, polyester substrate or softboard substrate or the like. That selection is preferably provided in a drop-down menu window for easy selection by the vendor.

In FIGS. 6 and 7, the Material Properties category 90 contains information for the material identified in the General Information category 70. Preferably, the Material Properties category 90 includes five different sections, namely Material Configuration 92, Mechanical Properties 94, Thermal Properties 96, Electrical Properties 98 and Environmental Properties 100. The Material Properties category 90 is used by the vendor to provide specific information about the various material properties. The database illustrated only provides for a single scalar value for each property to be entered. However, the database is preferably configured so that the vendor can indicate material properties as a function of temperature, frequency, humidity, time, pressure, testing method and in X, Y, Z dimensions using tensor, scalar, equation, graphic and other data type formats.

As further shown, the data elements 104 for the Material Properties category 90 can be entered in a table format. Accordingly, the vendor enters multiple types of information for each property 92, 94, 96, 98, 100 as proper for that material. One or more of the data elements 104 can include a predetermined unit of measure or standard which the system may or may not allow the user to change.

The Material Configuration section 92 provides information on the size, thickness or other type of information about the material identified in the General Information category 70. For each variable 92, the vendor can indicate the Unit of Measure, Property Symbol, Nominal Data Value, Minimum Data Value, Maximum Data Value, the Testing Method used to measure the given data value, any Application Notes associated with that particular property, and a link to any Application Audio or Video clips. The vendor can also define whether or not all users have permission to access all or some of the data specified for any combination of data.

By establishing a hierarchy of category, section, element title and data element, the vendor is prompted to provide all information that may be necessary for the workstation user to have when using an EDA tool and when doing a search. Accordingly, the workstation user can have all available information about the material at one time when the information is needed.

All the information contained in the materials database 42a is searchable by the workstation user through the interface website 32. The categories 70, 80, 90, sections 92, 94, 96, 98, 100, element titles 72, 82, 92, 102, and data elements 74, 84, 94, 104 all form separate fields of information that can be independently searched. Thus, for instance, the workstation user can formulate a search that looks for matching terms only in the general information category 70 alone, for a particular element title alone, or in combination with one or more of the other categories, sections or data elements.

As a further example, a design rule database can be optionally provided to describe with precision the rules needed to design for example, for manufacture for lowest cost, fastest time to market, smallest size, etc., for a particular vendor's design or manufacturing process. The design rule database can include definitions of fields or vendor-supplied data terminology that can be used by the vendor when creating the vendor database 40. The design rule database, for instance, can include a super set list of all entities that defines technical terminology, a super set of relationship between entities that shows entities (materials/components, etc.) and their relationships with other entities, and a rules set that shows entities that are not normally used in combination with each other. The super set list can include the term pad, which is a terminal area with a hole, a land which is a terminal area for receiving a pin, and a finger which is a terminal used to engage an edge connector socket. The super set of relationships can show that the pad is commonly used with the land or finger.

A models database can also be provided that shows entities and their known or estimated equivalents which can then be used by the EDA tools for analysis and other work. Thus, for instance, if a search is conducted for a particular electrical circuit, the models database can include mechanical or electromagnetic (or fluid or thermal, etc.) equivalent circuits which can be used by the EDA tools to do various analysis under various conditions.

It should be understood that the number, arrangement and configuration of the categories, sections, element titles and data elements is exemplary only, and not intended to be limiting. The optimal number, arrangement and configuration of the databases 40 can be different within the meaning of the invention. The vendor database 40 is not limited by the illustrative embodiment, and can include additional structure. Likewise, the structure and configuration of the models, design rules and component databases are not limited by the illustrative embodiment for the materials database 42a. The vendor has the option of completing all information for the databases, restricting certain information to authorized users, or providing additional information in the row designed for “others.”

The present system 5 provides benefit to all parties involved in the design process at all levels of the supply chain, including but not limited to Service Providers, Systems, Sub-systems, Packaged Components, Unpackaged Components, Engineered Materials and Raw Materials. For OEMs, the system reduces costs and decreases the time to market. A workstation user can compare and analyze data from vendors on a worldwide basis. Errors in communicating complex design information are virtually eliminated throughout the supply chain. Standardized databases structures are used for materials, design rules, models, components, etc. in order to provide consistent and reliable information. The workstation user can quickly and accurately conduct tradeoff analysis to locate the best materials, processes and vendors, and the number of design and prototype iterations are minimized.

EDA tool vendors also benefit from the present system 5. EDA tools are easier to use with standardized data and the tools can be more widely used. In addition, the cost of library development through access to vendor data is reduced. Likewise, vendors have a worldwide sales channel that directly connects the vendor with customers before and during the critical design-in phase when the designer is looking for information and alternatives. Furthermore, confusion and delay in communicating complex technical information is drastically reduced.

It is further noted that the system 5 (and its elements) can be placed behind a firewall on a company intranet of an OEM or other user. The advantage of using a firewall is that the user's organization can develop and manage its own private and internal set of databases 40 that are highly secure from the outside world. Also, a company can have a full suite of EDA design tools 20 that are only accessible by authorized users behind the company's firewall. Thus, the company can have a fully networked Neutral Dynamic Hub for all EDA tools behind the firewall and a fully Neutral Dynamic Hub enabled EDA tool suite. The firewall embodiment includes all of the features of the “public” system, such as the ability of the vendor to manage or limit the vendor-supplied data that can be downloaded to a workstation.

In addition, a set of management tools can be provided that manage and/or limit the types of vendors to whom the workstation users can collect and use data from. That “qualified supplier list” ensures that the workstation user only uses suppliers and supplier products/services that have been qualified and/or approved by the user's company. Any search results can therefore be limited only to those suppliers on the qualified supplier list, or indicate which suppliers are qualified and which are not (such as by using a viewing filter, color, screen position blinking or other type of marking). The qualified vendors can further be classified into different hierarchies of preference, and search results can indicate the preferred vendors.

Alternatively, the search results can show both qualified and unqualified vendors. However, before any unqualified vendor-supplied data is permitted to be downloaded from a vendor database 40, the workstation user can be required to obtain an “electronic permission” from a manager. The “electronic permission” releases the data to be downloaded to the workstation. The various qualified supplier list management systems can be used with or without a firewall.

Another advantage of the system 5 is that the workstation users can share the Neutral Dynamic Hub at the EPDeS web site 32. Each user does not need to have a Neutral Dynamic Hub or other file transfer software at the workstation 10, and instead the workstation user can pay for each use or pay based on some combination of uses or time of the Neutral Dynamic Hub (or other CAD File Transportability software or other software) for each file transfer. Accordingly, the workstation user does not need to pay a full license fee and instead CAD File Interoperability is provided on a “per use” basis. In addition, the EPDeS web site 32 can manage design sessions using the CAD File Translation software and using the Neutral Dynamic Hub in order to keep track of all of the data integrity issues for a particular design, on a pay-per-use or other basis.

In addition, multiple levels of security can be established for vendor-supplied data at the vendor databases 40. Certain of the vendor-supplied data, for instance, can be designated as public-accessible, and other levels can require different levels of security authorization. The vendor databases can be encrypted to enforce security and to ensure that only authorized subscribed users can access the information. The vendor-supplied data can then be decrypted by the EPDeS web site 32 or at the workstation or the EDA tool or some other suitable place on the network.

Another feature of the invention is that the workstation user can enter comments into the vendor-supplied data or the design file or elsewhere in the system that can be viewed by subsequent users. For instance, assume that the user searches, downloads and imports vendor-supplied data into an EDA tool, and determines that there are problems with the vendor-supplied data, the vendor or the design. That workstation user can add a comment to the vendor-supplied file or the vendor-database so that a subsequent user can read the comment. The comments can be saved at the EPDeS web site 32, such as in the registry database 34, and associated with the particular URL associated with the vendor data file 40a . . . n. Comments can also be obtained and used for any other aspect of the system 5. As another feature of the invention, selected information captured by the EPDeS web site 32 to register a password for a user can be provided to selected vendors.

Though the registry database 34 has been described as implemented at the central web site 32, the registry database 34 can instead be provided at the user workstation 10. The workstation 10 can also include a search engine that searches the vendor databases 40. Thus, the workstation 10 can directly communicate with the registry database 34 and/or search the vendor databases 40 without having to access the central web site 32. This can have particular usefulness when the system 5 is implemented behind a firewall.

Yet another feature of the present invention is that the EPDeS web site 32 can automatically notify the workstation user if a new vendor product or service gets posted to a vendor database that meets the user's search criteria. Search criteria can be saved at the EPDeS web site or user workstation and automatically searched when a new vendor database or vendor data file is added. If a match is found, the user can be automatically notified, such as by an email or post to the user's account.

In addition, a session database can be provided within the system 5 to maintain the from/to transports of design files and vendor-supplied data used for a particular design. The session database is created when a user first logs onto the system and identifies a particular product that is being designed. Each time the user re-enters the system and logs on, the history of all previous EDA tool transports and vendor-supplied data are made available for that particular design. Accordingly, users (designers and others) from all over the world can collaborate on a given design project, using the Neutral Dynamic Hub and vendor-supplied data. The session settings database can be used for both the public and firewall implementations of the system 5.

It should be recognized that the examples are for illustrative purposes only and do not limit the invention. The examples merely serve to illustrate the flexibility of the system. Therefore, it is not desired to limit the invention to the specific examples disclosed or the exact construction and operation shown and described. Rather, all suitable modifications and equivalents may be resorted to, falling within the scope of the invention.

I claim:

1. A design system comprising:
at least one vendor database containing data provided in a standardized database structure;
a registry database containing selected information from said at least one vendor database; and,
a user workstation for receiving search criteria input by a user and searching said registry database based on the search criteria.

2. The design system of claim 1, further comprising a central server, said user workstation forwarding the search criteria to said central server for searching said registry database based on the search criteria.

3. The design system of claim 1, wherein said user workstation searches said at least one vendor database in response to the searching said registry database.

4. The design system of claim 1, wherein the data contained in said at least one vendor database includes information about a material or process.

5. The design system of claim 1, further comprising a design tool, wherein the data having the standardized database structure is recognizable by said design tool.

6. The design system of claim 1, further comprising a session database for retaining a history of user activity.

7. The design system of claim 6, wherein the history relates to a specific product or process.

8. The design system of claim 6, wherein the session database can be accessed by the user workstation.

9. The design system of claim 1, wherein a vendor can filter selected vendor-supplied data that can be downloaded from said vendor database.

10. The design system of claim 1, wherein user information is sent to a vendor.

11. The design system of claim 1, wherein said user workstation includes a browser for searching said registry database based on the search criteria.

12. A design system comprising at least one vendor database having at least one data file containing data relating to a product or process provided by the vendor, said data having a standardized database structure, and a user workstation for receiving search criteria input by a user, searching said at least one vendor database in response to the search criteria, receiving search results associated with data from said at least one vendor database and downloading data associated with the search results into a workstation database.

13. The design system of claim 12, further comprising a registry database having selected data from said at least one vendor database.

14. The design system of claim 13, wherein the user workstation conducts a preliminary search of said registry database based upon the search criteria.

15. The design system of claim 14, wherein the user workstation searches said at least one vendor database in response to the preliminary search.

16. The design system of claim 12, further comprising a central server, said user workstation forwarding the search criteria to said central server for searching said at least one vendor database based on the search criteria and providing the search results to said user workstation.

17. The design of claim 16, wherein said central server retains the search criteria, searches said at least one vendor database at a later time based on said retained search criteria, and forwards the search results to said user workstation.

18. The design system of claim 12, wherein the data contained in said at least one vendor database includes information about a material or process.

19. The design system of claim 12, further comprising a design tool, wherein the data having the standardized database structure is recognizable by said design tool.

20. The design system of claim 12, wherein said user workstation includes a browser for searching said at least one vendor database based on the search criteria.

21. The design system of claim 21, further comprising a session database for retaining a history of user activity.

22. The design system of claim 21, wherein the history relates to a specific product or process.

23. The design system of claim 12, wherein the session database can be accessed by the user workstation.

24. The design system of claim 12, wherein a vendor can filter selected vendor-supplied data that can be downloaded from said vendor database.

25. The design system of claim 12, wherein user information is sent to a vendor.

26. A design system comprising:
at least one vendor database containing vendor-supplied data;
a searching facility for searching said at least one vendor database in response to search criteria and generating search results associated with vendor-supplied data from said at least one vendor database; and,
a first user workstation for receiving search criteria input by a user and forwarding the search criteria to said searching facility, receiving search results from said search facility and downloading vendor-supplied data from said at least one vendor database associated with the search results into a vendor-supplied database, the first user workstation further having a first design tool for importing vendor-supplied data from the vendor-supplied database and creating a first design file in response to design criteria from the user.

27. The design system of claim 26, further comprising a second design tool for importing the first design file and vendor-supplied data from the vendor-supplied database and creating a second design file in response to design criteria from the user.

28. The design system of claim 27, wherein the second design tool is located at a second user workstation, wherein said first user workstation transmits the first design file and the vendor-supplied database to said second user workstation.

29. The design system of claim 28, wherein the second design tool is located at said first user workstation.

30. The design system of claim 26, further comprising a neutral dynamic hub for receiving the first design file and the vendor-supplied database, reformatting the first design file and transmitting the reformatted first design file and vendor-supplied database to a second design tool.

31. The design system of claim 30, wherein said neutral dynamic hub and the second design tool are located at said first user workstation.

32. The design system of claim 30, wherein said neutral dynamic hub and the second design tool are located at a second user workstation.

33. The design system of claim 26, further comprising a registry database having selected vendor-supplied data from said at least one vendor database.

34. The design system of claim 33, wherein the searching facility conducts a preliminary search of said registry database based upon the search criteria.

35. The design system of claim 34, wherein the searching facility searches said at least one vendor database in response to the preliminary search.

36. The design system of claim 26, wherein the vendor-supplied data includes information about a material or process.

37. The design system of claim 26, wherein the vendor-supplied data is retained in said vendor database in a standardized format that is recognizable by different design tools.

38. The design system of claim 26, wherein said searching facility controls access to the vendor-supplied data at said vendor database.

39. The design system of claim 26, wherein said searching facility comprises a browser.

40. The design system of claim 26, further comprising a session database for retaining a history of user activity.

41. The design system of claim 40, wherein the history relates to a specific product or process.

42. The design system of claim 40, wherein the session database can be accessed by the user workstation.

43. The design system of claim 26, wherein a vendor can filter selected vendor-supplied data that can be downloaded from said vendor database.

44. The design system of claim 26, wherein user information is sent to a vendor.

45. The design system of claim 26, wherein said searching facility retains the search criteria, searches said at least one vendor database at a later time based on said retained search criteria, and forwards the search results to said user workstation.

46. The design system of claim 26, wherein said first user workstation, said searching facility and said at least one vendor database are located behind a firewall and are connected by a local network or intranet.

47. The design system of claim 26, further comprising a qualified supplier list containing a list of at least one qualified vendor database, said searching facility only downloading vendor-supplied data from the at least one qualified vendor database.

48. The design system of claim 47, wherein said qualified supplier list is stored at said user workstation.

49. The design system of claim 47, wherein said qualified supplier list is stored at said searching facility.

50. The design system of claim 26, wherein a vendor can filter selected vendor-supplied data that can be downloaded from said vendor database.

51. The design system of claim 26, wherein said user workstation accesses said vendor database and said searching facility through a global network.

52. The design system of claim 26, wherein said at least one vendor database is located at said searching facility.

53. The design system of claim 26, wherein said at least one vendor database is located at a remote server.
